(19) United States
(12) Patent Application Publication
(10) Pub. No.: US 2005/0157199 A1
(43) Pub. Date: Jul. 21, 2005

(54) Video camera

(76) Inventor: Shoichi Aoki, Kanagawa (JP)

Correspondence Address: FORMMER LAWRENCE & HAUG LLP, 745 FIFTH AVENUE, NEW YORK, NY, 10151, US

(21) Appl. No.: 11/037,570

(22) Filed: Jan. 18, 2005

(30) Foreign Application Priority Data
Jan. 19, 2004 (JP) P2004-010744

(51) Int. Cl. H04N 5/232

(52) U.S. Cl. 348/360

(57) ABSTRACT

To adjust a focus exactly. This invention provides a camera body 2 and an exchangeable AF lens 3 that can be attached to or removed from the camera body 2 and can be used in both an auto focus mode and a manual focus mode. The exchangeable AF lens 3 is provided with a scale 31 around a focusing ring 9 used for adjusting a focus. Thereby, a focus can be adjusted exactly based on the scale 31 of the focusing ring 9 even in the manual focus mode.

### BACKGROUND OF THE INVENTION

1. Field of the Invention

This invention relates to a video camera and, more particularly, is suitably applied to a broadcasting/professional-use video camera in which a camera body and an exchangeable lens can be attached to and separated from each other.

2. Description of the Related Art

In most of broadcasting/professional-use video cameras, a main body and a lens part are fixed to each other. We adjust a focus automatically, or by manually rotating a zoom adjustment ring of the lens part (for example, refer to Japanese Patent Laid-open No. 2003-60957).

In a manual focus mode, the broadcasting/professional-use video cameras have a drawback in that we cannot exactly adjust a focus because we manually rotate the zoom adjustment ring while looking through a view finder and therefore the focus is adjusted based on our viewing, not based on a rotation amount of the zoom adjustment ring.

Since broadcasting/professional-use video cameras for high definition video systems (HDVS) offer very good picture quality, what the focus cannot be adjusted exactly is a problem.

### SUMMARY OF THE INVENTION

This invention has been made in view of foregoing, and proposes a video camera capable of more exactly adjusting a focus even in a manual focus mode.

To solve the above problem, this invention provides a camera body and an exchangeable lens operable in both an auto focus mode and a manual focus mode. The exchangeable lens has a scale around a focusing ring for adjusting a focus, thus making it possible to realize a video camera capable of more exactly adjusting a focus based on the scale of the focusing ring even in the manual focus mode.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a schematic perspective view of an auto focus video camera according to this invention;

FIG. 2 is a schematic side view of the auto focus video camera;

FIG. 3 shows a focus adjustment mechanism;

FIGS. 4 to 8 are schematic views of scales of a focusing ring;

FIG. 9 is a schematic view of a scale of a focusing ring according to another embodiment; and

FIG. 10 is a schematic view of a construction of the scale of the focusing ring of the other embodiment.

### DETAILED DESCRIPTION OF THE EMBODIMENT

Preferred embodiments of this invention will be described with reference to the accompanying drawings:

(1) Entire Construction of an Auto Focus Video Camera

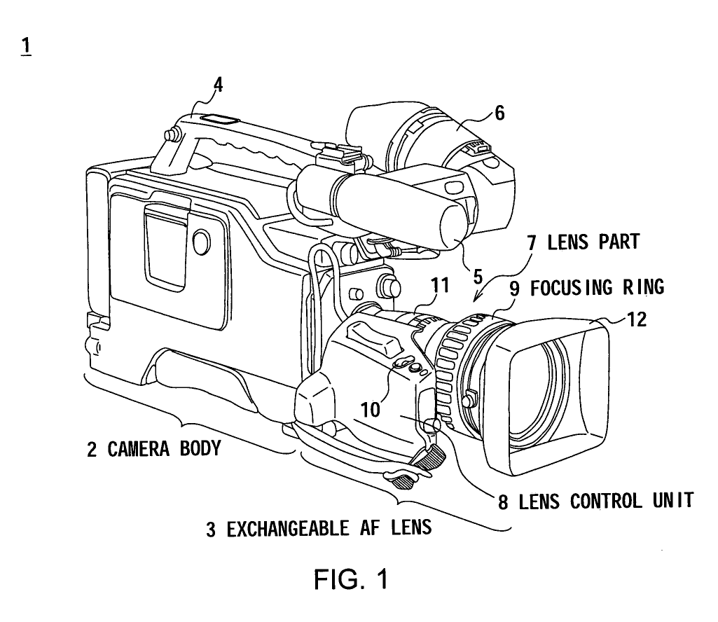

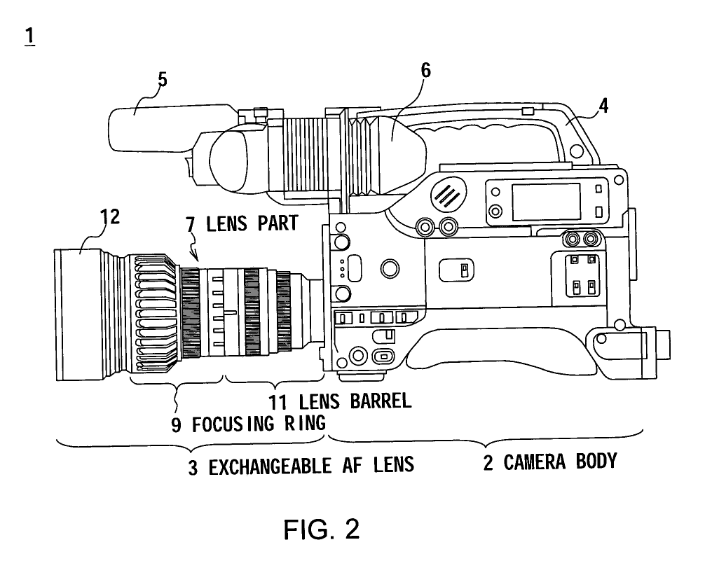

Referring to FIG. 1 and FIG. 2, reference numeral 1 shows an auto focus video camera according to this invention which is used for broadcasting/professionals in high definition video system (HDVS). A camera body 2 and an exchangeable auto focus (AF) lens 3 can be attached to and separated from each other.

The camera body 2 is equipped with a handle gripper 4, a microphone 5 for collecting sounds, and a view finder 6.

The exchangeable AF lens 3 is composed of a lens part 7 and a lens control unit 8. In the lens part 7, a focus adjustment lens (not shown) is provided and a focusing ring 9 is attached to a lens barrel 11. In addition, a hood 12 is attached to this lens part 7. The lens control unit 8 adjusts a focus by moving the focus adjustment lens.

The lens control unit 8 of the exchangeable AF lens 3 being attached to the camera body 2 receives power supply from the camera body 2 and adjusts a focus with the power.

In such the auto focus video camera 1, the exchangeable AF lens 3 can be attached and removed, so that another exchangeable AF lens with a different zoom ratio can be used instead.

Further, in this auto focus video camera 1, a switch 10 is provided to the lens control unit 8 of the exchangeable AF lens 3 to allow a cameraman to desirably switch between an auto focus mode and a manual focus mode.

In the auto focus video camera 1 in the auto focus mode, a focus is automatically adjusted under the control of the lens control unit 8. In the manual focus mode, on the other hand, the focus is adjusted by moving the focus adjustment lens (not shown) provided in the exchangeable AF lens 3 according to cameraman's rotation of the focusing ring 9.

In this connection, the auto focus video camera 1 adopts the HDVS offering much better picture quality than the conventional standard definition (SD) system. Therefore, pictures are out of focus unless the cameraman adjusts a focus exactly.

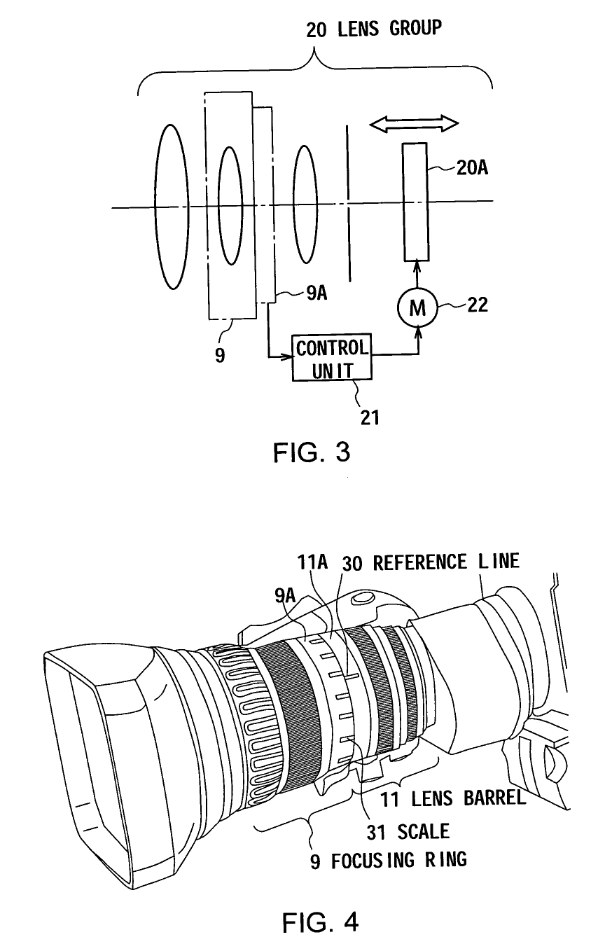

Specifically, as shown in FIG. 3, the auto focus video camera 1 has a lens group 20 in the lens part 7. When the cameraman rotates the focusing ring 9, the amount of the rotation is transmitted to a motor 22 via a control unit 21 from a rotary encoder 9A operating together with the focusing ring 9, so that the motor 22 moves the focus adjustment lens 20A in directions indicated by an arrow.

Thus, the auto focus video camera 1 can move the focus adjustment lens 20A according to cameraman's rotation of the focusing ring 9. That is, the focus is adjusted manually.

This exchangeable AF lens 3 does not directly operate in conjunction with the focusing ring 9 and the focus adjustment lens 20A, but indirectly operates via the rotary encoder 9A and the motor 22. Therefore, the focusing ring 9 rotates to both the right and the left without no limitation.

For example, in the manual focus mode, to adjust a focus to re-shoot a first subject after shooting a next subject by panning after shooting the first subject, the cameraman has to remember how much he rotated the focusing ring 9.

However, since the cameraman rotates the focusing ring 9 while looking through the view finder 6, it is hard for the cameraman to return the focus by correctly memorizing the rotation amount of the focusing ring 9.

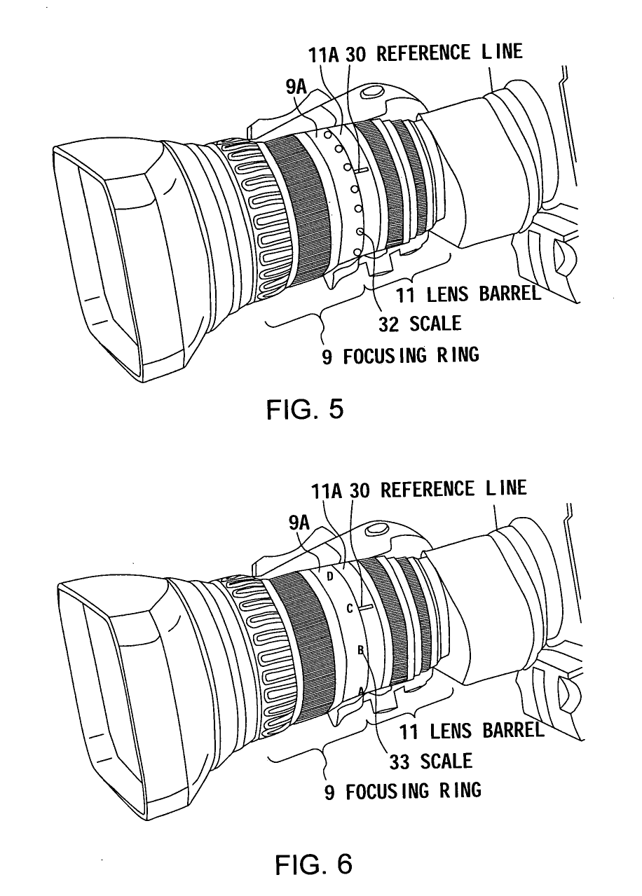

As shown in FIG. 4, in the camera focus video camera 1, a scale 31 is provided around an edge part 9A of the focusing ring 9 contacting the lens barrel 11 and one reference line 30 is provided on an edge part 11A of the lens barrel 11 contacting the focusing ring 9.

Therefore, the auto focus video camera 1 can allow the cameraman to easily confirm how much he/she rotated the focusing ring 9, based on a positional relation between the scale 31 and the reference line 30.

In this case, since the scale 31 provided around the edge part 9A of the focusing ring 9 is the one to indicate a rotation amount of the focusing ring 9 based on a positional relation with the reference line 30, numerals should not be provided.

In the auto focus video camera 1, instead of the above scale 31, a scale 32 comprising ◯ marks can be provided around the edge part 9A of the focusing ring 9 as shown in FIG. 5. Alternatively, a scale 33 comprising the alphabet can be provided as shown in FIG. 6. This can let the cameraman confirm the rotation amount of the focusing ring 9 based on the number of times of rotations of the focusing ring 9 and the position of the scale 32, 33 even if he/she keeps on rotating the focusing ring 9.

In addition, in the auto focus video camera 1, a scale 34 comprising marks such as ◯, Δ, □, and x can be provided around the edge part 9A of the focusing ring 9 as shown in FIG. 7. Alternatively, a scale 35 comprising ◯ marks of different sizes can be provided as shown in FIG. 8.

Specifically, the cameraman who uses the scale 35 in which ◯ marks of different sizes are arranged in an order of size can intuitively recognize the rotational direction based on the sizes of the marks when adjusting a focus by rotating the focusing ring 9.

(2) Operation and Effects

According to the above configuration, in the auto focus video camera 1, a scale 31-35 other than numerals is provided around the edge part 9A of the focusing ring 9 to be rotated, and one reference line 30 is provided on the edge part 11A of the lens barrel 11 contacting the focusing ring 9. Therefore, when a focus is adjusted by rotating the focusing ring 9 in the manual focus mode, the cameraman can correctly recognize how much he/she rotated or should rotate the focusing ring 9, based on a positional relation between the scale 31-35 and the reference line 30.

The cameraman memorizes the position of the scale 31-35 with respect to the reference line 30 when adjusting a focus to the subject in the manual focus mode, and to adjust the focus to the subject again, he/she just rotates the focusing ring 9 so that the memorized position of the scale 31-35 matches the reference line 30.

In addition, by providing a scale 31-35 comprising marks other than numerals, the auto focus video camera 1 can let the cameraman recognize the rotation amount of the focusing ring 9 as a relative value not as an absolute value. Even if the exchangeable AF lens 3 is changed to another exchangeable AF lens, the scale 31-35 can be effectively used as an indicator for adjusting a focus.

According to the above configuration, in the auto focus video camera 1, a scale 31-35 other than numerals is provided around the edge part 9A of the focusing ring 9 which is rotated to adjust a focus and one reference line 30 is provided on the edge part 11A of the lens barrel 11 contacting the focusing ring 9, thereby realizing exact focus adjustment based on the scale 31-35 in the manual focus mode.

(3) Other Embodiments

Note that the above embodiment has described a case where this invention is applied to an auto focus video camera used as a broadcasting/professional-use digital VTR for HDVS. This invention, however, is not limited to this and can be applied to other video cameras such as digital VTRs using optical discs as recording media, provided that a focus can be adjusted in a manual focus mode.

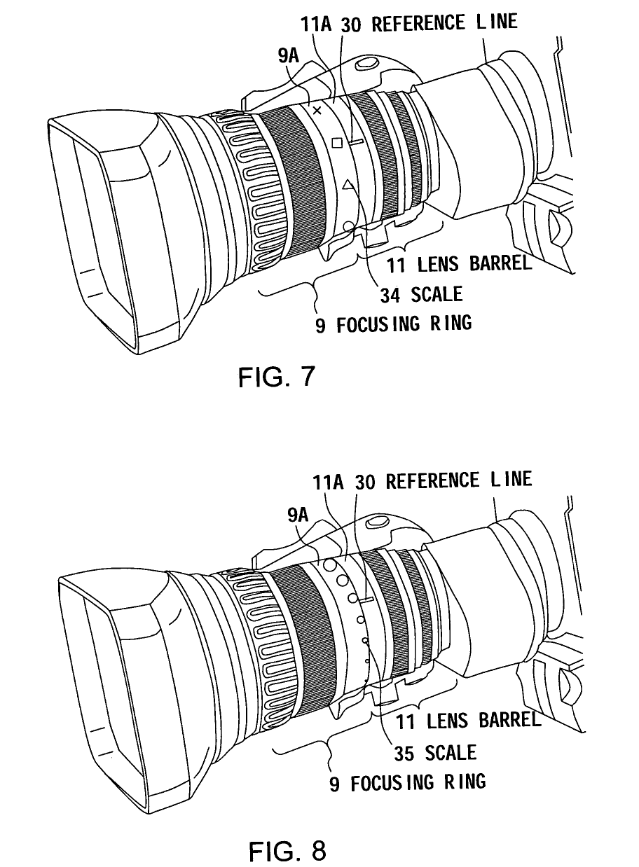

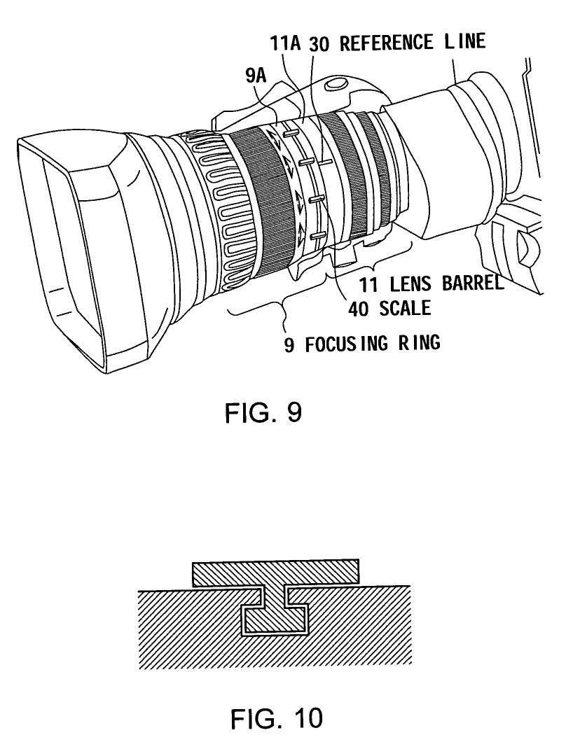

Further, the above embodiment has described a case where a scale 31-35 other than numerals is provided as shown in FIG. 4 to FIG. 8. This invention, however, is not limited to this and, as shown in FIG. 9 and FIG. 10, a scale can be created in such a manner that a thin groove is formed on the edge part 9A of the focusing ring 9 and a white projection 40 is inserted into the groove so that the projections can be slid as the scale.

In this case, by matching the projection 40 to the reference line 30 when adjusting a focus to a subject, the cameraman may just match the reference line 30 to the projection 40 to re-adjust a focus to the subject and he/she does not necessarily memorize a positional relation between the scale and the reference line 30.

Furthermore, the above embodiment has described a case where a scale 31-35 is provided around the edge part 9A of the focusing ring 9. This invention, however, is not limited to this and the scale 31-35 can be provided around another part of the focusing ring 9.

Furthermore, the above embodiment has described a case where the one reference line 30 is provided on the edge part 11A of the lens barrel 11. This invention, however, is not limited to this and one more reference line can be provided at a position opposite to the reference line 30.

Furthermore, the above embodiment has described a case where the auto focus video camera 1 of this embodiment is applied as a broadcasting/professional-use video camera for HDVS. This invention, however, is not limited to this and can be applied to cameras for other purposes.

A video camera of this invention is a video camera having an exchangeable AF lens attached thereto and this invention can be used for adjusting a focus in a manual focus mode.

While there has been described in connection with the preferred embodiments of the invention, it will be obvious to those skilled in the art that various changes and modifications may be aimed, therefore, to cover in the appended claims all such changes and modifications as fall within the true spirit and scope of the invention.

1. A video camera comprising:
a camera body; and
an exchangeable lens attachable to and removable from said camera body, and usable in both an auto focus mode and a manual focus mode, wherein
said exchangeable lens is provided with a scale around a focusing ring used for adjusting a focus.

2. The video camera according to claim 1, wherein
said scale comprises marks other than numerals.

3. A lens attached to a video camera, comprising:
a reference line provided on a lens barrel of said lens; and
a scale provided on a focusing ring so as to allow a position with respect to said reference line to be confirmed.

4. A video camera comprising:
a video camera body;
a lens attached to said video camera body;
a reference line provided on a lens barrel of said lens; and
a scale provided on a focusing ring so as to allow a position with respect to said reference line to be confirmed.

5. The video camera according to claim 4, wherein
said lens is an exchangeable lens and is usable in both an auto focus mode and a manual focus mode.
